(19) United States
(12) Patent Application Publication
(10) Pub. No.: US 2003/0031377 A1
(43) Pub. Date: Feb. 13, 2003

(54) Apparatus and method for removing block artifacts, and displaying device having the same apparatus

(75) Inventor: Jong-Hak Ahn, Anyang-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/191,530

(22) Filed: Jul. 10, 2002

(30) Foreign Application Priority Data
Aug. 13, 2001 (KR) 2001-48791

(51) Int. Cl. G06K 9/40; G06T 5/00; H04N 5/21

(52) U.S. Cl. 382/268; 382/262; 375/240.29

(57) ABSTRACT

An apparatus and a method for removing block artifacts. The block artifacts removing apparatus has a decoding unit for decoding decoded image data, and a post-processing unit for post-processing to remove the block artifacts after extracting frame data in regard to the decoded image data and a compression attribute of the frame data from the decoding unit. Accordingly, the block artifacts removing apparatus can be applied to various systems since the block artifacts removing apparatus uses information generated from the decoder, and has a simple logic circuit.

### BACKGROUND OF THE INVENTION

1. Field of the Invention

The present invention relates to an apparatus and a method for removing block artifacts, and a displaying device having the apparatus for removing the block artifacts, and more particularly to an apparatus and a method for removing block artifacts, and a displaying device having the block artifacts removing apparatus capable of removing the block artifacts generated when restoring image data compressed as a block unit. The present application is based on Korean Patent Application No. 2001-48791, filed Aug. 13, 2001, which is incorporated herein by reference.

2. Description of the Related Art

Most of the image code standards currently used internationally compress image data in units of a block. It is well known to use a block code such as a block DCT (Discrete Cosine Transform) in a code system that effectively compresses codes relating to still image data or motion image data. One of the biggest problems of the block-based image coding method is that at high compression ratios, a block artifact generates a block-type line which did not exist in an original image.

To transmit a large amount of image information through a transmission channel having a restricted bandwidth, the image data must be compressed. The compression of the image data is performed by removing some information from the image signal. Since the compression process, which removes some of the image information (high-frequency information) is individually operated for each block in the block-based coding, a discontinuity is generated at a block boundary. Thus, a block form, which does not exist in the original image signal, is visually displayed.

To remove the above block artifact, some approaches have been variously introduced. FIG. 1 is a view schematically showing a conventional block artifacts removing apparatus according to one of the conventional approaches.

Referring to FIG. 1, an input digital image signal ‘X’ passes through a base-band pass filter 101, and is divided into a high-pass signal 103 and a low-pass signal 104, after being filtered by a reducer 102. The high-pass signal 103 is filtered with a median filter 105 since the block artifacts are included in the range of the high-pass signal 103. Then, the filtered high-pass signal 103 passes through digital filter circuits 106, 108 and is filtered with the low-pass signal 104 at an adder 109. Therefore, an image signal ‘Y’ not having the block artifacts is obtained. At this time, to aggressively perform filtering by dividing into a state having a large amount of block artifacts and a state having a small amount of block artifacts, a control logic unit 110 controls an attribute ‘K’ of the filter in accordance with the magnitude of a quantization level showing a compression degree.

As described above, most conventional block artifacts removing arts have an apparatus for detecting whether the image is compressed by a large amount or a small amount, and a digital filtering device having an attribute to be determined in accordance with the detection. Accordingly, there is a problem that the conventional block artifacts removing apparatus should have a multiplier and an adder in a complicated digital filter logic circuit.

### SUMMARY OF THE INVENTION

The present invention has been made to overcome the above-mentioned problems of the related art. Accordingly, it is an object of the present invention to provide an apparatus and a method for removing block artifacts having a simplified logic circuit.

The block artifacts removing apparatus to accomplish the above object includes a decoding unit for decoding the compressed image data, and a post-processing unit for post-processing to remove the block artifacts by extracting frame data for the decoded image data and a compression attribute information of the frame data from the decoding unit.

It can be realized that the decoding unit includes a memory having the compression attribute information, and the post-processing unit extracts the compression attribute information for each of the frame data from the memory. The displaying device having the block artifacts removing apparatus to accomplish the above object includes a decoding unit for decoding a compressed image data, a post-processing unit for post-processing to remove the block artifacts by extracting a decoded frame data and a compression attribute information of the frame data from the decoding unit, and a displaying unit for displaying the frame data post-processed in the post-processing unit.

On the other hand, the block artifacts removing apparatus according to the present invention provides a block artifacts removing method including the steps of: decoding the compressed image data; post-processing to remove the block artifacts after extracting a decoded frame data and a compression attribute information of the frame data in the decoding step; and a displaying unit for displaying the frame data post-processed in the post-processing unit. The compression attribute information includes bit-rate information and picture mode information for each of the frame data.

Here, the post-processing step further includes the steps of: comparing the bit-rate information with a minimum threshold value and a maximum threshold value which are previously determined; and processing mean filtering when the bit-rate information is less than the minimum threshold value, and omitting the post-processing when the bit-rate information is greater than the maximum threshold value.

Moreover, the post-processing step further includes the steps of: judging whether the picture mode information is either I picture mode, P picture mode, or B picture mode, when the bit-rate information is greater than the minimum threshold value and less than the maximum threshold value; and post-processing a corresponding frame data when the picture mode is the I picture mode.

Furthermore, it is preferable that the post-processing step further includes the steps of: judging whether the movement of the block is more than a predetermined value, when the picture mode is either the P picture mode or the B picture mode; and post-processing a corresponding frame data, when the movement of the block is more than the predetermined value. Here, the post-processing step performs post-processing using the same value of the post-processed value of the previous frame data, when the movement of the block is less than the predetermined value.

As described above, the block artifact removing apparatus and the method having a simple logic circuit and a reduced amount of filtering is provided.

### BRIEF DESCRIPTION OF THE DRAWINGS

The above-mentioned objects and the features of the present invention will be more apparent by describing the preferred embodiment of the present invention by referring to the appended drawings, in which:

FIG. 1 is a block diagram schematically showing a conventional block artifact removing apparatus;

FIG. 2 is a block diagram schematically showing a block artifact removing apparatus according to the present invention;

FIG. 3 is a flow chart showing the process of removing the block artifacts using the apparatus of FIG. 2; and

FIG. 4 is a block diagram schematically showing a displaying device having the block artifacts removing apparatus of FIG. 2.

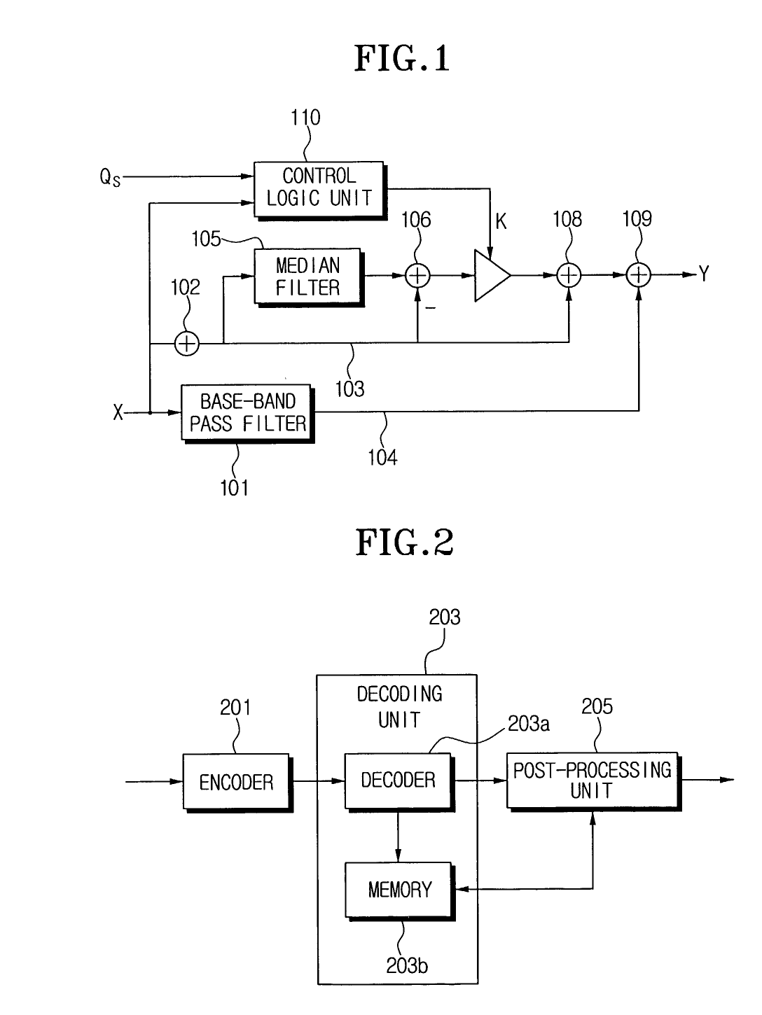

### DESCRIPTION OF THE PREFERRED EMBODIMENT

Hereinbelow, the preferred embodiment of the present invention will be described in great detail by referring to the appended drawings.

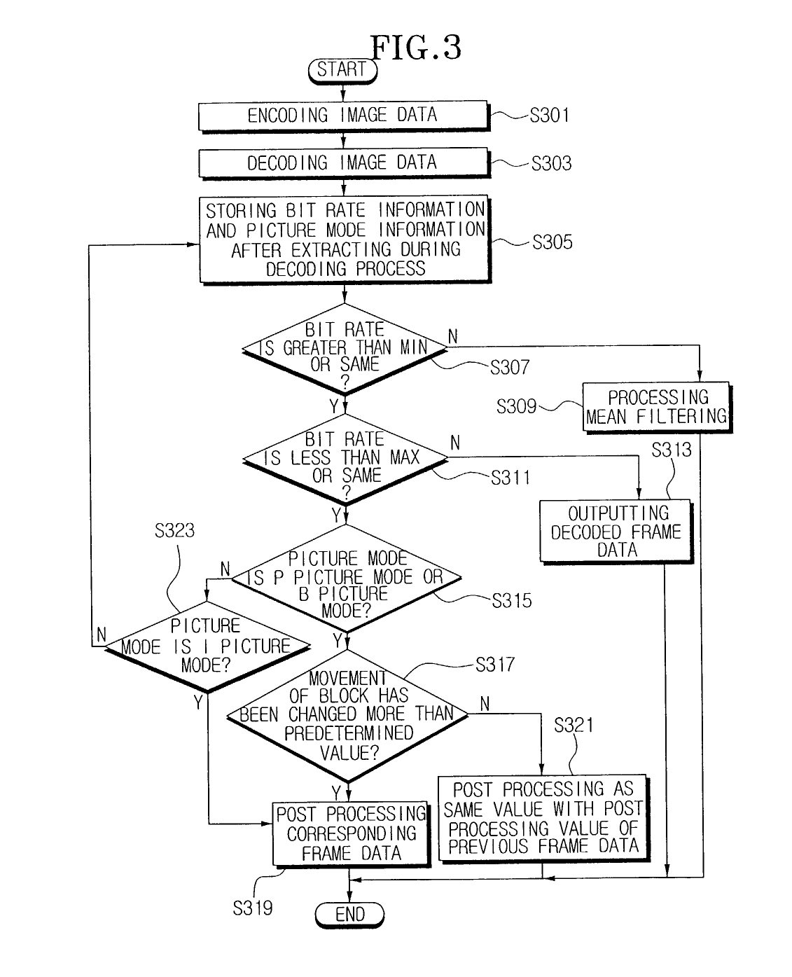

FIG. 2 is a block diagram showing a block artifacts removing apparatus according to the present invention. Referring to FIG. 2, the block artifacts removing apparatus includes an encoder 201 for removing block artifacts, a decoding unit 203, and a post-processing unit 205. On the other hand, the decoding unit 203 includes a decoder 203a and a memory 203b. The encoder 201 encodes input image data by bit-rate controlling. The image data compression to remove some information in the image data is performed in the process of block-based coding. A bi-directionally predictive coding method generally applied with an MPEG (Moving Picture Experts Group) standard is used as a compressing method of the image data. Three types of coding such as coding with a frame, inter-frame forward predictive coding, and bi-directionally predictive coding are used for the bi-directionally predictive coding method. Each coded image is referred to as an I picture (Intra coded picture), a P picture (Predictive coded picture), or a B picture (Bi-directionally predictive coded picture).

Moreover, when compression coding image data for digital broadcasting, it is necessary to maintain a high quality picture while at the same time restricting the amount of data (i.e., the bit rate) which is transmitted after the data compression process. Therefore, a statistic multiplexing method is used for compression coding of the image data. Statistic multiplexing is a method for transmitting more programs over a transmission line for a predetermined amount of transmitted data, and the transmission rates of corresponding programs are changed. Even though the overall transmission rate is reduced, more programs can be transmitted because in statistic multiplexing the transmission rate of some programs can be reduced without causing a deterioration in picture quality.

Usually, the encoder 201 is represented as TM5 (Test Model Editing Committee: “Test Model 5”: ISO/IEC JTC/SC292/WG11/N0400 (April 1993)), and encodes an image by bit-rate controlling using GOP (Group of picture) units. In other words, the bit-rate does not change within a GOP. However, the encoder 201 can encode by determining a target amount per frame unit instead of controlling the bit-rate by GOP unit.

The decoding unit 203 comprises a decoder 203a and a memory 203b.

The decoder 203a receives an image signal coded by the encoder 201, and decodes the coded image signal. For example, the decoder 203a decodes in accordance with the MPEG format. The image signal transmitted from the encoder 201 is decoded by the decoder 203a using an inverse VLC (Variable Length Coding) process, an inverse quantization process, and an inverse DCT process.

The memory 203b stores compression attribute information of the image data decoded after receiving the compression attribute information from the decoder 203a. The compression attribute information includes bit-rate information and picture mode information. The picture mode information is decoding information of three types: I picture, P picture, and B picture.

The post-processing unit 205 receives the decoded image signal from the decoder 203, the bit-rate information and the picture types of each frame image (I picture, P picture, B picture) from the memory 203a, and performs block raster conversion in accordance with transmitted information.

Here, the block raster is a term related to the region of a CRT (Cathode Ray Tube) monitor or a LCD (Liquid Crystal Display) monitor capable of displaying an image. The block raster in the CRT is a horizontal projection line that quickly scans an electric beam from the left side to the right side and from the top to the bottom as in a TV Braun tube. The block raster in the LCD is scanned differently than in the CRT, and image elements are individually displayed. The raster in the LCD is usually fit to the size of the monitor. If a low resolution is used (for example, when setting up a resolution of 640×480 in a LCD monitor adapted for 800×600), an image is displayed on only one part of the screen. On the contrary, if a high resolution is used, (for example, when setting up a resolution of 1,024×768 in a LCD monitor adapted for 800×600), the image is greater than that which can be displayed, so that a user must scroll to see an entire picture.

FIG. 3 is a flow chart showing a block artifacts removing process using the apparatus of FIG. 2. Referring to FIG. 2, the encoder 201 codes the input image data using a bit-rate controlling process (S301). The image data coded by the encoder 201 is transmitted to the decoding unit 203. The decoder 203a of the decoding unit 203 decodes the image data transmitted from the encoder 201. The bit-rate information and the picture mode information of the frame data generated during the decoding process are extracted and stored in the memory 203b (S305).

The post-processing unit 205 receives the decoded image signal from the decoder 203a, the bit-rate information and the picture mode information of each frame picture from the memory 203b, and performs block raster conversion in accordance with the transmitted information. The post-processing unit 205 has a different post-processing in accordance with transmitted bit-rate information from the memory 203b.

The bit-rate information represents a compression rate of the image data. Therefore, it is determined on the basis of the bit-rate information whether post-processing is performed. If the bit-rate is lower than a predetermined minimum threshold value, it can be assumed that the image data is highly compressed. On the other hand, if the bit-rate is higher than a predetermined maximum threshold value, it can be assumed that the image data is only a little compressed.

The bit-rate information is compared with the minimum threshold value and the maximum threshold value which have been previously established. If the bit-rate information is less than the minimum threshold value (S307), the post-processing unit 205 post-processes the corresponding frame data by applying mean filtering (S309). Here, the mean filtering takes an average value of the data and is applied differently from a general method. In other words, if the value of nth and n=1st is the boundary of the block, the value after the filtering is as follows. If x(n−1)<x(n+2), then Y(n)=x(n−1)+{x(n+2)−x(n−1)}×⅓, Y(n+1)=x(n−1)+{x(n−1)−x(n+2)}×⅔. If x(n−1)>x(n+1), then Y(n)=x(n−1)−{x(n+2)−x(n−1)}×⅓, Y(n+1)=x(n−1)−{x(n−1)−x(n+2)}×⅔. The reason mean filtering is applied is that simple mean filtering has a similar effect as that of a complicated algorithm, because when the bit-rate information is less than the minimum threshold value, distortion of the image data is increased.

If the bit-rate information is greater than the minimum threshold value (S307), the post-processing unit 205 judges whether the bit-rate information is less than the maximum threshold value (S311). If the bit-rate information is greater than the maximum threshold value, the post-processing unit 205 outputs the decoded frame data without performing post-processing in regard to the corresponding frame data (S313). Since few block artifacts in regard to the frame data have been generated, post-processing is not needed. Here, the minimum threshold value and the maximum threshold value are obtained after repeating experiments, and stored in the memory (not shown) of the post-processing unit 205 during a manufacturing procedure.

When the bit-rate information is less than the maximum threshold value or the same as the maximum threshold value, the post-processing unit 205 judges the picture mode of the corresponding frame data. If the picture mode of the frame data is judged as the P picture mode or the B picture mode (S315), the post-processing unit 205 judges whether the movement of the block of the corresponding frame data is more than a predetermined value (S317). If the movement of the block of the frame data is more than the predetermined value, the post-processing unit 205 post-processes the corresponding frame data (S319).

If the movement of the block of the frame data is not more than the predetermined value, the post-processing unit 205 post-processes the corresponding frame data with the same post-processing value used for the corresponding frame data of the previous frame (S321).

When the post-processing unit 205 judges that the picture mode of the corresponding frame data (S323) is an I picture, the post-processing unit 205 post-processes the corresponding frame data (S319). If the post-processing unit 205 judges that the picture mode of the corresponding frame data is not the I picture mode, the post-processing unit 205 performs post-processing with the described method by being provided again the bit-rate information and the picture mode information from the memory 203b of the decoding unit 203. After the above steps have been performed, the block artifacts removing method performed by the block artifacts removing apparatus according to the present invention is complete.

Here, there are various methods for post-processing performed by the block artifacts removing apparatus: a low-pass filtering method, a double converting method, a POCS (Projection Onto Convex Sets) method, and a conversion coefficient optimum estimating method.

The low-pass filtering method means that a discontinuity of the block boundary has a waveform somewhat similar to a step pulse and a large amount of energy is generated in a frequency range. Thus, the block artifacts are reduced by low filtering the high frequency.

The double converting method reduces the discontinuity at the block boundary by allowing some overlapping between the blocks when encoding and decoding. The POCS method obtains a more natural image by repeatedly projecting a decode image to a convex set by utilizing knowledge related to a coefficient range and a general attribute of the original image.

The conversion coefficient optimum estimating method rectifies the decoded conversion coefficient a little to allow the discontinuity at the block boundary to be minimized, since the block artifacts are basically generated when there is much error in quantizing the conversion coefficient.

Here, the post-processing 205 can apply either method among the four methods.

Therefore, the block artifacts removing apparatus has a simple logic circuit and can reduce the amount of filtering.

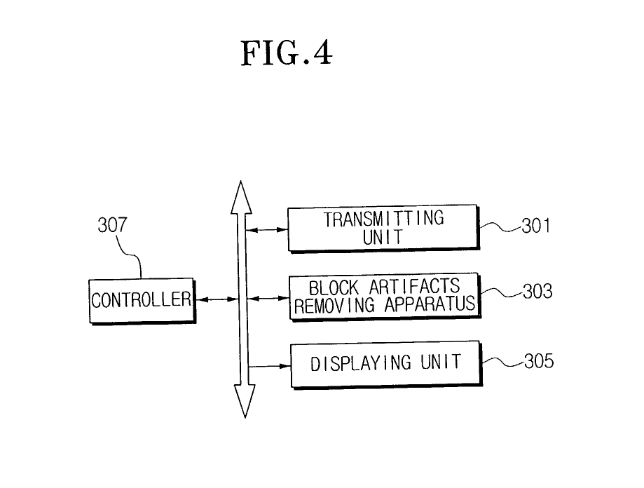

FIG. 4 is a block diagram showing a displaying device having the block artifacts removing apparatus of FIG. 2. The displaying device comprises a transmitting unit 301, the block artifacts removing apparatus 303, a displaying unit 305, and a controller 307.

The transmitting unit 301 transmits image data with a peripheral device (not shown) connected with the displaying device.

The block artifacts removing apparatus 303 is the same as the block artifacts removing apparatus in FIG. 2, thus the description will be omitted here. The displaying unit 305 displays the image signal from which the block artifacts have been removed. Moreover, when the block artifacts rarely exist, the displaying unit 305 displays the image signal by directly receiving the image signal from the transmitting unit 301.

The controller 307 is installed in the displaying device. The controller 307 controls the transmitting unit 301, the block artifacts removing apparatus 303, and the displaying unit 305.

Hereinbelow, the operation of the displaying device having the block artifacts removing apparatus will be described.

The image data transmitted from the transmitting unit 301 is transmitted to the block artifacts removing apparatus 303 by the controller 307. The block artifacts removing apparatus 303 removes the block artifacts generated in the frame data of the image data using the method which has been described above. For frame data from which the block artifacts have been removed, the frame data is transmitted to the displaying unit 305 by the controller 307. For frame data in which it is not necessary to remove block artifacts, the controller 307 transmits the frame data to the displaying unit 305 without passing though the block artifacts removing apparatus 303. The method for judging whether or not the block artifacts should be removed is done according to the method described above.

As described above, the displaying device having the block artifacts removing apparatus can display the image data transmitted from the peripheral device more clearly.

According to the present invention, the block artifacts removing apparatus not only can reduce the amount of filtering although the block artifacts removing apparatus has a simple logic circuit, but also can perform a proper post-processing in accordance with the system since the block artifacts removing apparatus use needed information for post-processing after extracting the information from the decoder.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited within the described range but the following claims.

What is claimed is:

1. A block artifacts removing apparatus for removing block artifacts generated when restoring a compressed image data, comprising:
a decoding unit for decoding the compressed image data; and
a post-processing unit for post-processing the decoded compressed image data to remove the block artifacts by extracting frame data for the decoded image data and compression attribute information of the frame data from the decoding unit.

2. The block artifacts removing apparatus of claim 1, wherein
the decoding unit includes a memory having the compression attribute information, and
the post-processing unit extracts the compression attribute information for the frame data of each frame from the memory.

3. The block artifacts removing apparatus of claim 2, wherein the compression attribute information includes bit-rate information and picture mode information for each of the frame data.

4. A display device for displaying image data after removing block artifacts generated when restoring compressed image data, comprising:
a decoding unit for decoding the compressed image data;
a post-processing unit for post-processing the decoded compressed image data to remove the block artifacts after extracting frame data for the decoded image data and compression attribute information of the frame data from the decoding unit; and
a displaying unit for displaying the frame data post-processed by the post-processing unit.

5. The display device of claim 4, wherein
the decoding unit includes a memory having the compression attribute information, and
the post-processing unit extracts the compression attribute information for the frame data of each frame from the memory.

6. The display device of claim 5, wherein the compression attribute information includes bit-rate information and picture mode information for the frame data of each frame.

7. A block artifacts removing method for removing block artifacts generated when restoring compressed image data, comprising the steps of:
decoding the compressed image data; and
post-processing to remove the block artifacts after extracting frame data for the decoded image data and compression attribute information of the frame data in the decoding step.

8. The block artifacts removing method of claim 7, wherein the compression attribute information includes bit-rate information and picture mode information for the frame data of each frame.

9. The block artifacts removing method of claim 8, wherein the post-processing step further includes the steps of:
comparing the bit-rate information with a minimum threshold value which has been previously determined and a maximum threshold value which has been previously determined; and
processing mean filtering when the bit-rate information is less than the minimum threshold value, and omitting the post-processing when the bit-rate information is greater than the maximum threshold value.

10. The block artifacts removing method of claim 9, wherein the post-processing step further includes the steps of:
judging whether the picture mode information is I picture mode, P picture mode, or B picture mode, when the bit-rate information is greater than the minimum threshold value and less than the maximum threshold value; and
post-processing a corresponding frame data when the picture mode is the I picture mode.

11. The block artifacts removing method of claim 10, wherein the post-processing step further includes the steps of:
judging whether movement of a block is more than a predetermined value, when the picture mode is either the P picture mode or the B picture mode; and
post-processing a corresponding frame data, when the movement of block is more than the predetermined value.

12. The block artifacts removing method of claim 11, wherein the post-processing step performs post-processing using the same post-processing value of previous frame data, when the movement of the block is less than the predetermined value.
